(19) United States
(12) Patent Application Publication
(10) Pub. No.: US 2026/0241290 A1
(43) Pub. Date: Aug. 20, 2026

(54) Customized Video Game Generation and Publishing System and Method of Use

(71) Applicant: Adam Denoto, Brook Park, OH (US)

(72) Inventor: Adam Denoto, Brook Park, OH (US)

(21) Appl. No.: 19/321,491

(22) Filed: Sep. 8, 2025

Related U.S. Application Data
(60) Provisional application No. 63/759,581, filed on Feb. 18, 2025.

(51) Int. Cl. A63F 13/63; A63F 13/67; A63F 13/79; G06F 40/205

(52) U.S. Cl. CPC A63F 13/63; A63F 13/67; A63F 13/79; G06F 40/205

(57) ABSTRACT

A customized video game development system that enables users to create fully personalized video games without coding is disclosed. A server-side natural language processing (NLP) processor interprets the user inputs to identify game genre, mechanics, objectives, and design preferences. A machine learning engine dynamically selects optimal models based on historical user data and adapts game generation logic over time. A game design engine assembles rule sets, assets, and logic, and a code generation module translates the design into executable code compatible with one or more game engines. Users can preview, test, and modify games in real time, and the finalized games are published with configurable access levels. The system enables adaptive, AI-assisted game development, thereby democratizing game creation for users without technical expertise.

### CROSS-REFERENCE TO RELATED APPLICATION

The present application claims priority to, and the benefit of, U.S. Provisional Application No. 63/759,581, which was filed on Feb. 18, 2025, and is incorporated herein by reference in its entirety.

### FIELD OF THE INVENTION

The present invention generally relates to artificial intelligence systems and automated software platforms for digital content creation. More specifically, the invention relates to a customized video games development system configured to enable users to create and publish fully personalized video games without requiring any coding or programming skills. The system utilizes a client-server architecture in which user input is processed through natural language processing (NLP) and machine learning (ML) modules to generate structured game design parameters, executable code, and integrated game assets. The invention serves as an AI-assisted interface between users and game development tools, streamlining the entire game creation process for both novice and experienced users. Accordingly, the present disclosure makes specific reference thereto. Nonetheless, it is to be appreciated that aspects of the present invention are also equally applicable to other like applications, devices, and methods of manufacture.

### BACKGROUND

By way of background, the popularity of video games has grown exponentially across all demographics. Further, individuals who love playing video games desire to have games based on their own creative experiences. However, the process of developing a video game traditionally requires extensive knowledge of programming languages, game engines, asset integration, and debugging tools. These technical barriers significantly limit accessibility for creative individuals who lack software development skills.

Moreover, even for users who attempt to create games using available tools, the process can be time-consuming, complex, and expensive. Existing platforms often require prolonged development cycles, and independent creators may encounter level of difficulty in publishing or sharing their games due to limited distribution channels or high costs. Accordingly, individuals desire an intuitive, automated, and accessible system for developing personalized games without requiring coding and complex technical tools.

Therefore, there exists a long-felt need in the art for a system that enables individuals to design and publish video games without requiring knowledge of computer programming or software engineering. There is a long-felt need for a platform that democratizes game development and enables creative users to express their ideas freely through fully playable, shareable games. Additionally, there exists a long-felt need for an intelligent, automated solution that significantly reduces the time, cost, and complexity traditionally associated with game design, asset integration, and code generation. Furthermore, there is a long-felt need for a system that is user-friendly, scalable, and compatible across multiple devices and game engines. More specifically, there is a long-felt need for a system that utilizes artificial intelligence to interpret user input, generate personalized game content, and produces a playable game with minimal user intervention. Finally, there is a long-felt need for a platform that provides an end-to-end solution for game creation, testing, modification, and publishing.

The subject matter disclosed and claimed herein, in one embodiment, comprises an artificial intelligence-powered customized video games development system designed to facilitate the creation of personalized video games through natural language input. The system comprises a client-server architecture wherein a user accesses the platform via a client device to submit inputs such as textual descriptions, spoken commands, or selected options. The server includes a natural language processing (NLP) processor that interprets the user's inputs and converts them into structured design parameters. A machine learning engine dynamically selects optimized models based on historical data and user profiles, enabling intelligent asset and rule selection. A game design engine assembles game mechanics, story elements, and visual themes, and a code generation module translates the design into executable game code, which can be integrated with a variety of industry-standard game engines. The user may preview and test the game in real time, provide feedback, and publish the final version through a built-in sharing mechanism.

In this manner, the customized video games development system of the present invention fulfills the long-felt need for an intelligent, easy-to-use, and accessible solution for non-programmers who want to develop video games. The system provides users with a streamlined, AI-assisted workflow for creating playable, professional-quality games based on their ideas. The system automates the traditionally complex stages of parsing, design, coding, testing, and publishing, and reduces the technical barriers to game development. The system may be implemented as a web-based application, desktop platform, or mobile app and can accommodate varying skill levels and game complexity.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a customized video games generation and publishing system. The system includes a client device configured to receive input from a user via a graphical user interface, wherein the input comprises at least one of a free-form text, spoken command, or selected predefined options corresponding to game preferences. A server is coupled to the client device via a network and comprises a natural language processing (NLP) processor configured to parse the input into structured commands, a machine learning engine configured to dynamically select a model based on historical user data, generate personalized recommendations, and learn from user feedback, a game design engine to assemble game logic, rules, and assets, and a code generation module configured to convert the assembled game design into executable code compatible with one or more game engines.

In another aspect, a method for creating a customized video game using an AI-powered system is described. The method includes receiving, at a server, a user input from a client device, wherein the input comprises free-form text, spoken commands, or selected options related to desired game characteristics, parsing, by a natural language processing (NLP) processor, the input to identify at least a game genre, game mechanics, visual styles, objectives, and characters, selecting, by a machine learning engine, a model based on historical user data and the parsed input to generate a personalized game design, assembling, by a game design engine, game logic, assets, and templates based on the selected model, generating, by a code generation module, executable game code based on the assembled logic, previewing, by a test system, the generated game and receiving user feedback, and incorporating the user feedback and publishing the updated game on a gaming platform or via a shareable link.

In another embodiment, a computer-implemented method for developing and publishing a customized video game is disclosed. The method includes displaying a user interface on a client device, the interface comprising a game input section and access to an asset library, receiving user-generated input describing a game concept, including gameplay mechanics, story elements, and asset preferences, processing the input using a natural language understanding engine to extract structured game design data, training and updating a machine learning model using the user's design behavior and feedback, automatically generating a complete game design including logic, visuals, audio, and rules, compiling the design into executable code using a code generation system, enabling the user to preview and interact with the game through a testing interface, and publishing the game with configurable access settings for viewing, playing, or editing.

In one embodiment, the system generates a shareable hyperlink for the customized game, associates access control levels including view-only, playable, modifiable, or deletable permissions, and publishes the game to third-party platforms or online communities via an application programming interface (API).

In yet another aspect, training and updating the machine learning model includes collecting interaction data, including user modifications, playtest results, and feature selection frequency, and dynamically adjusting future game design suggestions based on learned user preferences.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of customized video games development system of the present invention in accordance with the disclosed structure;

FIG. 2 illustrates a block diagram showing the internal modules or functionalities of the game design engine of the customized video games development system in accordance with the disclosed architecture;

FIG. 3 illustrates a flow chart depicting a process of creating and publishing a game based on inputs from a user using the customized video games development system in accordance with the disclosed architecture;

FIG. 4 illustrates an exemplary user interface displayed to a user for initiation of creation of a customized game in accordance with the disclosed architecture;

FIG. 5 illustrates an exemplary interface showing an asset library including various assets that can be used for creating a game in accordance with the disclosed architecture;

FIG. 6 illustrates a flow chart depicting a process of sharing a customized game created using the system in accordance with the disclosed architecture; and

FIG. 7 illustrates a preview game user interface displaying preview of a game created using the system in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that enables individuals to design and publish video games without requiring knowledge of computer programming or software engineering. There is a long-felt need for a platform that democratizes game development and enables creative users to express their ideas freely through fully playable, shareable games. Additionally, there exists a long-felt need for an intelligent, automated solution that significantly reduces the time, cost, and complexity traditionally associated with game design, asset integration, and code generation. Furthermore, there is a long-felt need for a system that is user-friendly, scalable, and compatible across multiple devices and game engines. More specifically, there is a long-felt need for a system that utilizes artificial intelligence to interpret user input, generate personalized game content, and produces a playable game with minimal user intervention. Finally, there is a long-felt need for a platform that provides an end-to-end solution for game creation, testing, modification, and publishing.

The present invention, in one exemplary embodiment, is a method for creating a customized video game using an AI-powered system is described. The method includes receiving, at a server, a user input from a client device, wherein the input comprises free-form text, spoken commands, or selected options related to desired game characteristics, parsing, by a natural language processing (NLP) processor, the input to identify at least a game genre, game mechanics, visual styles, objectives, and characters, selecting, by a machine learning engine, a model based on historical user data and the parsed input to generate a personalized game design, assembling, by a game design engine, game logic, assets, and templates based on the selected model, generating, by a code generation module, executable game code based on the assembled logic, previewing, by a test system, the generated game and receiving user feedback, and incorporating the user feedback and publishing the updated game on a gaming platform or via a shareable link.

Reference will now be made in detail to the present preferred embodiments of the invention, examples of which are illustrated in the accompanying drawings. Wherever possible, the same reference numerals are used in the drawings and the description to refer to the same or like parts.

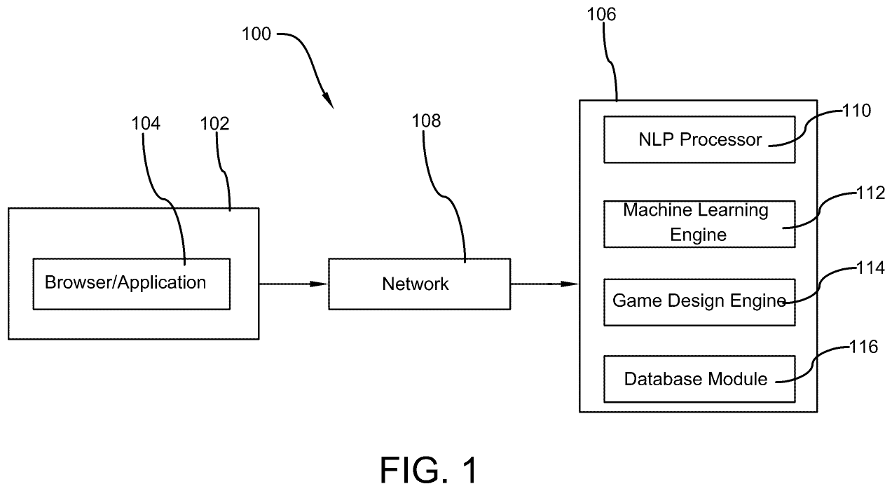

Referring initially to the drawings, FIG. 1 illustrates a schematic view of customized video games development system of the present invention in accordance with the disclosed structure. The customized video games development system 100 of the present invention is an artificial intelligence (AI)-powered software platform that enables users to design fully customized video games without any coding knowledge. The system 100 uses a combination of natural language processing (NLP), machine learning (ML), and code generation algorithms to translate user preferences into executable game logic, complete with graphics, music, mechanics, and rules.

More specifically and preferably, the customized video games development system 100 uses a client-server architecture wherein a user accesses the functionalities offered by the system 100 using a client device 102 via an application or a browser 104. It should be noted that application and browser are used interchangeably in the present disclosure. The client device 102 is coupled to a server 106 via a network 108, such as Internet. The client device 102 can be any computing device, such as a mobile device like a personal computing device, desktop, laptop, smartphone, PDA, smartwatch, etc.

As used herein, the term “server” means a server computer or group of computers that act to provide a service for a certain function or access to a network resource. The servers may be physical servers, hosted servers in a virtual environment, or software code running on a platform. The term “application” means software used on a computer by a user and can be applications that are targeted or supported by specific classes of machine, such as mobile application, desktop application, tablet application, enterprise application, and so on. The “client device” refers to any computer, embedded device, mobile device, or other system that can be used to perform the functionality described as being performed by the client device. Specifically, client devices include devices which can be used to display a user interface by which the functionality provided by a server can be utilized by a user.

The server 106 includes a natural language processing (NLP) processor 110 and is configured to parse user input, such as free text or any provided options, into structured commands for creating a customized game using tokenization and stemming. Tokenization is the process of issuing a digital, unique, and anonymous representation of a real thing. Stemming is the process of reducing base words to their base form. The NLP Processor 110 receives free-form textual input or spoken commands from the user interface provided by the application 104, and the input may include a game genre, details of visual style, mechanics, game objectives, and characters. The tokenization breaks the text into tokens and stemming reduces the words to base forms for further processing. The NLP processor 110 parse action requests and understands game type, environment, and more using trained deep learning models such as transformer-based models like BERT, Bidirectional Encoder Representations from Transformers, and GPT, Generative Pre-training Transformer.

A machine learning engine 112 is configured to learn continuously from past user inputs (i.e., collects history) in the system 100 and identify usage patterns to improve game generation accuracy. Specifically, the machine learning engine 112 collects data from a plurality of sources, such as user-created games, user inputs, game performance metrics such as playset success, and all the data is stored in an encrypted training database embedded in the machine learning engine 112. The machine learning engine 112 also dynamically selects the best-performing model for a given task of creating a customized game based on user inputs.

A game design engine 114 creates logic, rules, and different flows of the game based on the model selected by the machine learning engine 112 and parsed input by the NLP processor 110. The game design engine may select a game template from a list of game templates suggested by the machine learning engine 112, and further, an executable code is automatically generated by the game design engine 114 for creating and rendering the customized game. The game can be previewed by a user and can also be modified based on feedback from the user.

The server 106 includes a plurality of individual and independent databases in the database module 116 for storing user profiles, including user preferences, various game assets such as characters, game templates, and more. Different modules and engines of the system 100 uses data from the database module 116 for generating a customized game as per preferences and input from the users.

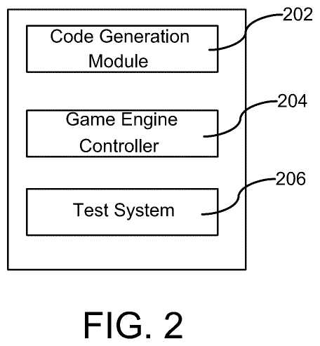

FIG. 2 illustrates a block diagram showing the internal modules or functionalities of the game design engine of the customized video games development system in accordance with the disclosed architecture. The game design engine 114 includes a code generation module 202 that translates a game design into executable code or source code. The source code generated by the code generation module 202 can be integrated into various APIs used in game engines. The code generation module 202 includes the functionality of debugging and compiling the code for a successful execution of the code for generating a game.

A game engine controller 204 interfaces with various game engines and submits or passes the code to the game engine. Further, the game engine controller 204 also formats the code into a format or language supported by the corresponding game engine. A test system 206 is designed to automatically preview and test created games before integration with the game engines. The test system 206 also enables a user to preview and test the game, and displays different performance metrics of the game to the user.

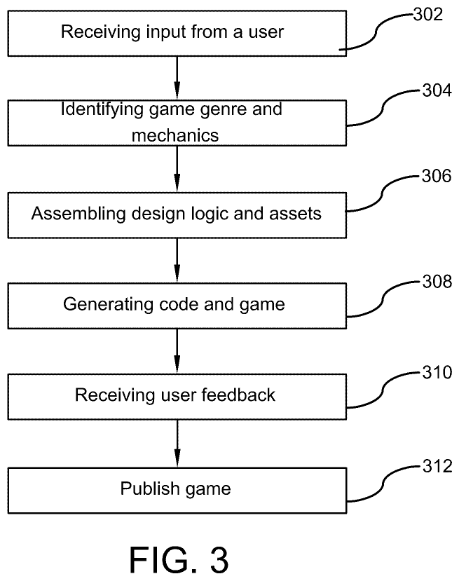

FIG. 3 illustrates a flow chart depicting a process of creating and publishing a game based on inputs from a user using the customized video games development system in accordance with the disclosed architecture. Initially, the system 100 receives input from the user via a graphical user interface (GUI) (Step 302) and the input can be in the form of one or combination from free-form text (such as “Build a 3D universe adventure with a magic wand, an astronaut and multiple planets), predefined options (genre, level of difficulty, mechanics, art style), or uploaded custom scripts.

Then, the user input is parsed using natural language processing to identify game genre, game mechanics, objectives, challenges, and more (Step 304). In the next step, based on identified game attributes, game logic (rule sets, player movement), design templates, and asset packs (such as visuals, audio, character models, background art) are assembled (Step 306). Thereafter, the game logic is automatically compiled into an executable code as described earlier in the disclosure (Step 308).

On a playable version of the game, a user can test the game, suggest modifications, and provide direct feedback, which is received and incorporated in the customized game (Step 310). Finally, the updated game can be exported to a standalone format (PC, mobile, web) and can also be shared with a gaming platform or community (Step 312).

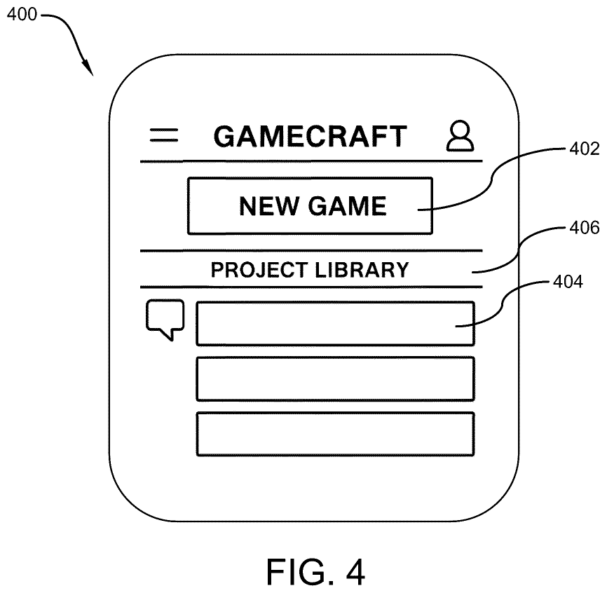

FIG. 4 illustrates an exemplary user interface displayed to a user for initiation of creation of a customized game in accordance with the disclosed architecture. The user interface 400 displays a “New Game” icon 402, which can be selected for providing inputs for creating a new game. Inputs can be provided in free-form textual input, spoken commands, or scripts using the structured commands or input controls 404. For assistance in creating a game, a project library comprising various already created games can be accessed using a “Project Library” icon 406. It should be noted that the existing projects visible to the user can be based on the profile and past interactions of the user.

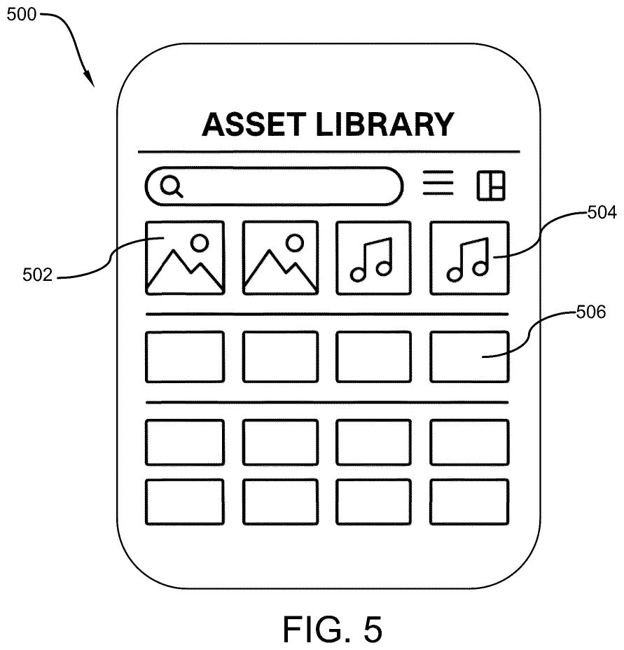

FIG. 5 illustrates an exemplary interface showing an asset library including various assets that can be used for creating a game in accordance with the disclosed architecture. The asset library interface 500 enables users to browse and manage different assets that can be used in designing and creating video games using the system 100. As illustrated, the interface 500 displays a plurality of visual assets 502, such as backgrounds, tile sets, and more related to visuals, a plurality of music and sound effects 504, a plurality of animations 506, and more to customize the game as per preferences of users. It should be noted that assets corresponding to each aspect of a video game can be included in the interface 500 for enabling users to choose and customize the video game.

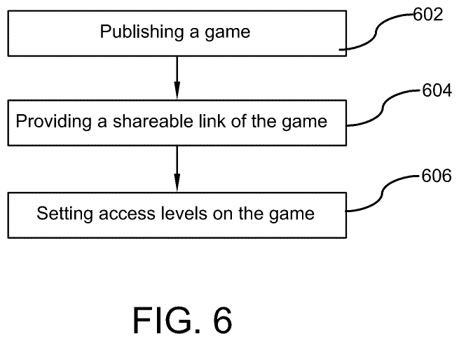

FIG. 6 illustrates a flow chart depicting a process of sharing a customized game created using the system in accordance with the disclosed architecture. When a game is created, including feedback from a user, the game is published for rendering and/or on various game engines (Step 602). Then, the system 100 creates a shareable link which can be used to directly access and possibly play the game (Step 604). Finally, along with the shareable link, access level of the game can also be defined by the user, wherein the access levels can be for only viewing the game, playing the game, customizing the game, and deleting the game (Step 606).

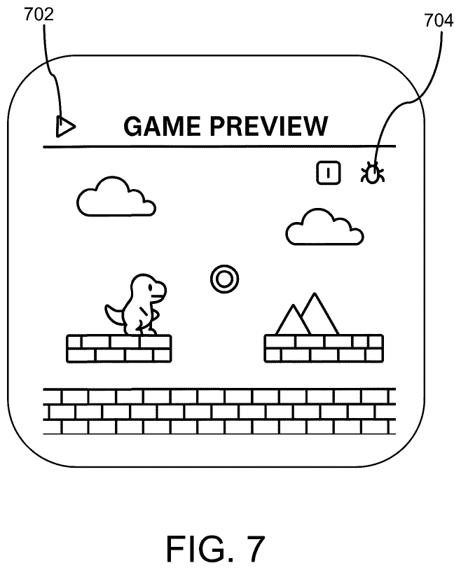

FIG. 7 illustrates a preview game user interface displaying preview of a game created using the system in accordance with the disclosed architecture. The preview game user interface 700 enables a user to see a preview of the game and test the game using the simulation button 702. Any bugs or changes in the functionality can be provided as feedback using the feedback button 704.

The system 100 of the present invention does not require coding, and based on user-defined inputs, a custom video game is created. The preview enables fast iterations and learning, and using the system 100 becomes personalized and smart using the machine learning based improvements.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “customized video games development system”, “game generation and publishing system”, and “system” are interchangeable and refer to the customized video games generation and publishing system 100 of the present invention.

Notwithstanding the foregoing, the customized video games generation and publishing system 100 of the present invention can be of any suitable configuration as is known in the art without affecting the overall concept of the invention, provided that it accomplishes the above-stated objectives. One of ordinary skill in the art will appreciate that the customized video games generation and publishing system 100, as shown in the FIGS. are for illustrative purposes only, and that many other configurations of the customized video games generation and publishing system 100 are well within the scope of the present disclosure. Although the dimensions of the customized video games generation and publishing system 100 are important design parameters for user convenience, the customized video games generation and publishing system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A customized video game development system comprising:
a computing device;
a server;
a natural language processing;
a machine learning (ML) engine; and
a code generation module;
wherein said code generation module translates a user's input into executable game logic, graphics, music, mechanics, and rules for creating a video game;
wherein said computing device coupled to said server with access to an internet network;
wherein said computing device is selected from the group consisting of a personal computing device, a desktop, a laptop, a smartphone, a PDA, and a smartwatch;
wherein said server is a server computer selected from the group consisting of a physical server, a hosted server in a virtual environment, and a software code running on a platform;
wherein said server having said natural language processing (NLP) for parsing said user's input into structured commands to create said video game; and
further wherein said user's input includes free text.

2. The customized video game development system of claim 1, wherein said natural language processing uses tokenization for converting said user's input into structured commands for creating said video game.

3. The customized video game development system of claim 2, wherein said user's input includes selections selected from the group consisting of a game genre, a visual style, a game mechanic, a level of difficulty, a game objective, a character, a video, an audio, and a background art.

4. The customized video game development system of claim 3, wherein said machine learning engine collects said user's input history and identifies usage patterns for game generation accuracy; and further wherein said usage patterns selected from the group consisting of a user-created game, said user's input, and a game performance metric.

5. The customized video game development system of claim 4, wherein said machine learning engine selects a model for creating said video game based on said user's input.

6. The customized video game development system of claim 5 further comprising a game design engine for creating logic, rules, and different flows of said video game based on said model selected by said machine learning engine.

7. The customized video game development system of claim 6, wherein said game design engine selects a game template from a list of game templates suggested by said machine learning engine.

8. The customized video game development system of claim 7, wherein said code generation module translates said game design engine into executable code for creating and rendering said video game.

9. The customized video game development system of claim 8, wherein said server includes a plurality of independent databases in a database module for storing user profiles selected from the group consisting of user preferences, game characters, and game templates.

10. A method of customizing a video game, the method comprising the steps of:
providing a computing device; a server; a natural language processing; a machine learning (ML) engine; and a code generation module;
translating with said code generation module a user's input into executable game logic, graphics, music, mechanics, and rules for creating a video game;
coupling said computing device to said server with access to an internet network, wherein said computing device is selected from the group consisting of a personal computing device, a desktop, a laptop, a smartphone, a PDA, and a smartwatch, further wherein said server is a server computer selected from the group consisting of a physical server, a hosted server in a virtual environment, and a software code running on a platform; and
parsing said user's input into structured commands with said natural language processing to create said video game, wherein said user's input includes selections selected from the group consisting of free text, a game genre, a visual style, a game mechanic, a level of difficulty, a game objective, a character, a video, an audio, and a background art.

11. The method of customizing a video game of claim 10, wherein said natural language processing uses tokenization for converting said user's input into structured commands for creating said video game.

12. The method of customizing a video game of claim 11, wherein said machine learning engine collects said user's input history and identifies usage patterns for game generation accuracy; and further wherein said usage patterns selected from the group consisting of a user-created game, said user's input, and a game performance metric.

13. The method of customizing a video game of claim 12, wherein said machine learning engine selects a model for creating said video game based on said user's input.

14. The method of customizing a video game of claim 13 further comprising a game design engine for creating logic, rules, and different flows of said video game based on said model selected by said machine learning engine.

15. The method of customizing a video game of claim 14, wherein said game design engine selects a game template from a list of game templates suggested by said machine learning engine.

16. The method of customizing a video game of claim 15, wherein said code generation module translates said game design engine into executable code for creating and rendering said video game.

17. The method of customizing a video game of claim 16, wherein said server includes a plurality of independent databases in a database module for storing user profiles selected from the group consisting of user preferences, game characters, and game templates.

18. A method of customizing a video game, the method comprising the steps of:
providing a computing device; a server; a natural language processing; a machine learning (ML) engine; and a code generation module;
translating with said code generation module a user's input into executable game logic, graphics, music, mechanics, and rules for creating a video game;
coupling said computing device to said server with access to an internet network, wherein said computing device is selected from the group consisting of a personal computing device, a desktop, a laptop, a smartphone, a PDA, and a smartwatch, further wherein said server is a server computer selected from the group consisting of a physical server, a hosted server in a virtual environment, and a software code running on a platform;
parsing said user's input into structured commands with said natural language processing to create said video game, wherein said user's input includes selections selected from the group consisting of free text, a game genre, a visual style, a game mechanic, a level of difficulty, a game objective, a character, a video, an audio, and a background art; and
assembling a game logic selected from the group consisting of a rule set, a player movement, and a design template.

19. The method of customizing a video game of claim 18 further comprising a step of creating logic, rules, and different flows of said video game based on a model selected by said machine learning engine.

20. The method of customizing a video game of claim 19, wherein said code generation module translates said game design engine into executable code for creating and rendering said video game and further wherein said server includes a plurality of independent databases in a database module for storing user profiles selected from the group consisting of user preferences, game characters, and game templates.
